(19) United States
(12) Patent Application Publication
(10) Pub. No.: US 2012/0186060 A1
(43) Pub. Date: Jul. 26, 2012

(54) MANUFACTURING METHOD OF AN IRON-TYPE GOLF CLUB HEAD

(76) Inventor: Chi-Hung SU, Tainan City (TW)

(21) Appl. No.: 13/010,987

(22) Filed: Jan. 21, 2011

(51) Int. Cl. B23P 17/00; B23P 15/00

(52) U.S. Cl. 29/407.05; 29/592; 29/527.6

(57) ABSTRACT

A manufacturing method of an iron-type golf club head has acts of: forming a blank for an iron-type club head with a raw material selected from the group of medium-carbon and low-carbon steel, wherein the blank has a striking face integrally-formed; heating a center of the striking face on the blank to a predetermined quenching temperature; quenching the blank to cool down the blank rapidly to form a hardened layer, wherein a hardness of the striking face gradually decreases radially from the center to a periphery of the striking face; machining the striking face to form multiple grooves, and surface treating the blank to accomplish the iron-type golf club head. Therefore, the iron-type golf club head has a softer head body and a harder striking face to have the inclined angles of the hosels easily adjusted, as well as high resistance of the striking face.

### BACKGROUND OF THE INVENTION

1. Field of the Invention

The present invention relates to a manufacturing method of a golf club head, especially to a manufacturing method of an iron-type golf club head.

2. Description of the Prior Arts

The conventional iron-type golf club heads are manufactured by precision casting or forging. Since the conventional iron-type golf club heads are made of single steel, the conventional iron-type golf club heads is limited in performance characteristics and cannot satisfy the golf players' demand for striking.

For example, some of the conventional iron-type golf club heads are made of medium-carbon or low-carbon steels. Because the medium-carbon or low-carbon steels are softer, the striking faces on those conventional club heads can be easily machined to form grooves, and the inclined angles of the hosels on those conventional club heads can be easily adjusted. However, the striking faces on those conventional club heads have low wear-resistance and cannot perform long distance striking since the medium-carbon or low-carbon steels are softer.

For another example, some of the conventional iron-type golf club heads are made of high-carbon steels. Because the high-carbon steels are harder, the striking faces on those conventional club heads have high wear-resistance and can perform long distance striking. However, since the high-carbon steels are harder, machining the striking faces on those conventional club heads to form grooves is difficult, and the inclined angles of the hosels on those conventional club heads are difficult to be adjusted.

In order to overcome the problems of the conventional iron-type golf club heads made of single steel, some of the conventional iron-type golf club heads are made of two different steels. This conventional club head comprises a head body made of softer steel and a strike plate made of harder steel. The strike plate is welded, glued, or inlaid on/to the head body. However, the manufacturing process is thus made complicated since the head body and the strike plate are separately formed with different materials and then combined together by means of welding, gluing, or inlaying. Furthermore, the head body and the strike plate may not be combined closely enough since the head body and the strike plate are made of different materials.

To overcome the shortcomings, the present invention provides a manufacturing method of an iron-type golf club head to mitigate or obviate the aforementioned problems.

### SUMMARY OF THE INVENTION

The main objective of the present invention is to provide a manufacturing method of an iron-type golf club head. The manufacturing method has acts of: forming a blank for an iron-type club head with a raw material selected from the group of medium-carbon steel and low-carbon steel, wherein the blank has a striking face integrally-formed; heating a center of the striking face on the blank to a predetermined quenching temperature; quenching the blank to cool down the blank rapidly to form a hardened layer, wherein a hardness of the striking face gradually decreases radially from the center to a periphery of the striking face; machining the striking face to form multiple grooves, and surface treating the blank to accomplish the iron-type golf club head. Therefore, the iron-type golf club head has a softer head body and a harder striking face. The softer head body allows the inclined angles of the hosels on the club heads to be easily adjusted. The harder striking face has high wear-resistance, and the grooves on the striking face do not easily wear out so that the iron-type golf club head has an improved durability and thus a longer life span.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a manufacturing method of an iron-type golf club head in accordance with the present invention; and

FIG. 2 is a schematic view of a blank for the iron-type golf club head in accordance with the present invention, showing the distribution of the hardness of the striking face on the blank after quenching.

### DETAILED DESCRIPTION OF THE PREFERRED EMBODIMENTS

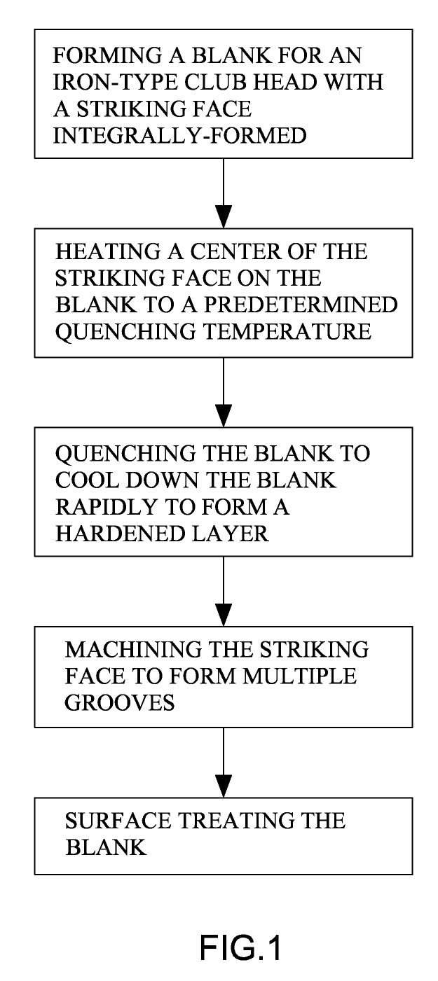

With reference to FIG. 1, a manufacturing method of an iron-type golf club head in accordance with the present invention comprises acts of forming a blank, heating a striking face on the blank, quenching the blank, machining the striking face on the blank, and surface treating the blank.

The blank is formed by precision casting or forging and has a striking face integrally-formed. The blank for an iron-type golf club head is made of raw material selected from medium-carbon steel with a carbon content from 0.25% to 0.6% and low-carbon steel with a carbon content below 0.25%.

Then a center of the striking face on the blank is heated to a predetermined quenching temperature. The heating method may be flame heating, medium or high frequency induction heating, electrical heating or the like. The predetermined quenching temperature is decided by the carbon content of the raw material for the blank and is lower than the transformation temperature of the raw material for the blank. The preferred relationship between the carbon content of the raw material for the blank and the predetermined quenching temperature is shown in Table I:

TABLE I
Comparison table of the carbon content and the predetermined
quenching temperature

| | Predetermined quenching |
|---|---|
| Carbon content (%) | temperature (° C.) |
| 0.12~0.18% | 780 ± 25° C. |
| 0.17~0.23% | 750 ± 25° C. |
| 0.22~0.29% | 720 ± 25° C. |
| 0.27~0.34% | 690 ± 25° C. |
| 0.32~0.39% | 660 ± 25° C. |
| 0.37~0.44% | 630 ± 25° C. |
| 0.42~0.50% | 600 ± 25° C. |
| 0.49~0.55% | 570 ± 25° C. |

One of the preferred embodiments is heating the blank made of raw material with a carbon content from 0.22% to 0.29% by flame heating. The flame heating comprises steps of positioning the blank on a jig with the striking face arranged horizontally and facing upward, adjusting the flame and the fuel gas of the flame gun to medium, aiming the gunpoint of the flame gun at the center of the striking face at a distance of about 70 mm, and heating the center of the striking face at 720±25° C. with the flame from the flame gun. During the heating step, a thermometer is used to measure the temperature of the center of the striking face. The thermometer may be a laser thermometer.

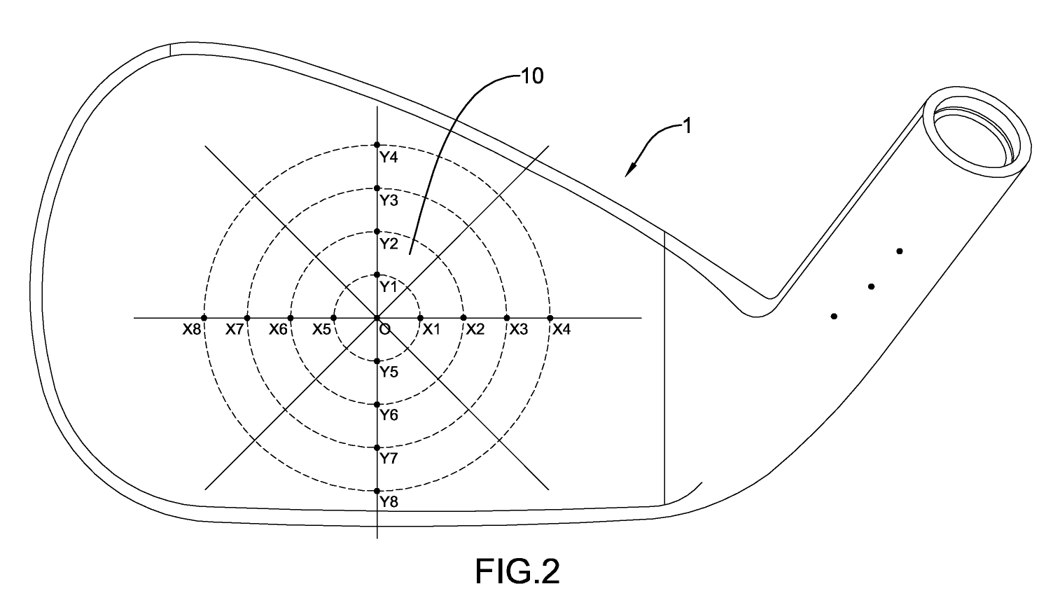

Then the blank is quenched to be cooled down rapidly so that the striking face on the blank is hardened and forms a hardened layer with a depth from 3 mm to 20 mm. The hardness of the striking face gradually decreases radially from the center to a periphery of the striking face. In a preferred embodiment, the blank is removed from the jig when the center of the striking face reaches the predetermined quenching temperature. The blank is immediately put into water or oil at a temperature from 5° C. to 80° C. to be quenched so that the striking face is cooled down rapidly to be hardened. Furthermore, because the flame directly heats the center of the striking face, the temperature of the center of the striking face is higher than the temperature of the periphery of the striking face. After quenching, the hardness of the striking face 10 on the blank 1 gradually decreases radially from the center to the periphery of the striking face 10. In a preferred embodiment as shown in FIG. 2, the hardness distribution of the striking face 10 on the blank 1 is represented by axis X and axis Y, whereon the adjacent points have a 5 mm-interval from each other. The preferred hardness is shown in Table II:

TABLE II
Hardness distribution table

| Position | X1 | X2 | X3 | X4 | X5 | X6 | X7 | X8 | O | Yl | Y2 | Y3 | Y4 | Y5 | Y6 | Y7 | Y8 |
|---|---|---|---|---|---|---|---|---|---|---|---|---|---|---|---|---|---|
| Hardness | 38 | 32 | 24 | 14 | 38 | 32 | 24 | 14 | 42 | 38 | 32 | 24 | 14 | 38 | 32 | 24 | 14 |
| (HRC) | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 | [symbol] 3 |

Then the striking face is machined to form multiple grooves at predetermined position with blades.

Then the blank is surface treated by means of polishing, cleaning, electroplating or the like to accomplish the iron-type golf club head.

With the manufacturing method as described, the iron-type golf club head has a softer head body since the blank is made of medium-carbon or low-carbon steel and also has a harder striking face since the striking face is heated and quenched. The softer head body allows the inclined angles of the hosels on the club heads to be easily adjusted. The harder striking face has high wear-resistance, and the grooves on the striking face do not easily wear out so that the iron-type golf club head has an improved durability and thus a longer life span. Given that the grooves do not easily wear out, the striking performance is enhanced and the striking distance prolonged. Further, the stability of ball controlling, the stability of ball flying path, and the ball spin rate are also well enhanced and increased. Moreover, the softer head body and the harder striking face are formed integrally to perform better striking

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A manufacturing method of an iron-type golf club head comprising acts of:
(a) forming a blank for an iron-type club head with a raw material selected from the group of medium-carbon steel and low-carbon steel, wherein the blank has a striking face integrally-formed;
(b) heating a center of the striking face on the blank to a predetermined quenching temperature;
(c) quenching the blank to cool down the blank rapidly to form a hardened layer, wherein a hardness of the striking face gradually decreases radially from the center to a periphery of the striking face;
(d) machining the striking face to form multiple grooves; and
(e) surface treating the blank to accomplish the iron-type golf club head.

2. The manufacturing method as claimed in claim 1, wherein
in step (b), the heating method is selected from the group of flame heating, medium frequency induction heating, high frequency induction heating and electrical heating; and
in step (b), the predetermined quenching temperature is decided by the carbon content of the raw material for the blank and is lower than the transformation temperature of the raw material for the blank.

3. The manufacturing method as claimed in claim 2, wherein step (b) further comprises an act of measuring the temperature of the center of the striking face with a thermometer.

4. The manufacturing method as claimed in claim 1, wherein step (c) further comprises an act of putting the blank into water or oil at a temperature from 5° C. to 80° C. when the striking face is heated to the predetermined quenching temperature to form the hardened layer with a depth from 3 mm to 20 mm.

5. The manufacturing method as claimed in claim 2, wherein step (c) further comprises an act of putting the blank into water or oil at a temperature from 5° C. to 80° C. when the striking face is heated to the predetermined quenching temperature to form the hardened layer with a depth from 3 mm to 20 mm.

6. The manufacturing method as claimed in claim 3, wherein step (c) further comprises an act of putting the blank into water or oil at a temperature from 5° C. to 80° C. when the striking face is heated to the predetermined quenching temperature to form the hardened layer with a depth from 3 mm to 20 mm.

7. The manufacturing method as claimed in claim 4, wherein in step (a), the blank is formed by precision casting.

8. The manufacturing method as claimed in claim 5, wherein in step (a), the blank is formed by precision casting.

9. The manufacturing method as claimed in claim 6, wherein in step (a), the blank is formed by precision casting.

10. The manufacturing method as claimed in claim 4, wherein in step (a), the blank is formed by forging.

11. The manufacturing method as claimed in claim 5, wherein in step (a), the blank is formed by forging.

12. The manufacturing method as claimed in claim 6, wherein in step (a), the blank is formed by forging.
